(19) United States
(12) Patent Application Publication
(10) Pub. No.: US 2026/0197849 A1
(43) Pub. Date: Jul. 9, 2026

(54) METHOD FOR RETRANSMITTING SL PRS, FIRST TERMINAL DEVICE, AND SECOND TERMINAL DEVICE

(71) Applicant: GUANGDONG OPPO MOBILE TELECOMMUNICATIONS CORP., LTD., Dongguan (CN)

(72) Inventors: Yang LIU, Dongguan (CN); Xinlei YU, Dongguan (CN)

(21) Appl. No.: 19/558,105

(22) Filed: Mar. 5, 2026

Related U.S. Application Data
(63) Continuation of application No. PCT/CN2023/139475, filed on Dec. 18, 2023.

(51) Int. Cl. H04W 72/25; H04L 1/1812

(52) U.S. Cl. CPC H04W 72/25; H04L 1/1812

(57) ABSTRACT

Provided is a method for retransmitting a sidelink positioning reference signal (SL PRS). The method is performed by a first terminal device. The method includes: retransmitting the SL PRS based on a shared resource pool, wherein transmission resources in the shared resource pool are used to transmit the SL PRS and/or data.

### CROSS-REFERENCE TO RELATED APPLICATION

This application is a continuation of International Application No. PCT/CN2023/139475, filed December 18, 2023, the entire disclosure of which is incorporated herein by reference.

### TECHNICAL FIELD

Embodiments of the present disclosure relate to the field of communication technologies, and in particular, relate to a method for retransmitting a sidelink positioning reference signal (SL PRS), and a first terminal device and a second terminal device thereof.

### RELATED ART

In sidelink positioning, a target terminal device may be positioned via an SL PRS.

### SUMMARY

Embodiments of the present disclosure provide a method for retransmitting an SL PRS, and a first terminal device and a second terminal device thereof. The technical solutions are as follows.

According to some embodiments of the present disclosure, a method for retransmitting an SL PRS is provided. The method is performed by a first terminal device, and the method includes:

retransmitting the SL PRS based on a shared resource pool, wherein transmission resources in the shared resource pool are used to transmit the SL PRS and/or data.

According to some embodiments of the present disclosure, a first terminal device is provided. The first terminal device includes a processor and a memory storing one or more computer programs, wherein the one or more computer programs, when executed by the processor, cause the first terminal device to:

retransmit the SL PRS based on a shared resource pool, wherein transmission resources in the shared resource pool are used to transmit the SL PRS and/or data.

According to some embodiments of the present disclosure, a second terminal device is provided. The second terminal device includes a processor and a memory storing one or more computer programs, wherein the one or more computer programs, when executed by the processor, cause the second terminal device to:

receive the SL PRS retransmitted by a first terminal device based on a shared resource pool, wherein transmission resources in the shared resource pool are used to transmit the SL PRS and/or data.

### BRIEF DESCRIPTION OF DRAWINGS

FIG. 1 is a schematic diagram of a network architecture according to some embodiments of the present disclosure;

FIG. 2 is a flowchart of a method for retransmitting an SL PRS according to some embodiments of the present disclosure;

FIG. 3 is a block diagram of an apparatus for retransmitting an SL PRS according to some embodiments of the present disclosure;

FIG. 4 is a block diagram of an apparatus for retransmitting an SL PRS according to some embodiments of the present disclosure; and

FIG. 5 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art understand that, with the evolution of the network architecture and the emergence of new service scenarios, the technical solutions according to the embodiments of the present disclosure are also applicable to similar technical problems.

Referring to FIG. 1, a schematic diagram of a network architecture according to some embodiments of the present disclosure is illustrated. The network architecture includes: a core network 11, an access network 12, and terminal devices 13.

The core network 11 includes a plurality of core network elements. The core network elements mainly function to provide user connection, user management, and service bearing, and serve as a bearer network to provide an interface to an external network. For example, the core network of a 5-th generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 includes various forms of macro base stations, micro base stations, relay stations, access points, and the like. The name of the device with functionality of an access network device varies in systems employing different radio access technologies. For example, the device is referred to as a gNodeB or a gNB in the 5G NR system. With the evolution of communication technologies, the name "access network device" may change. For the convenience of description, the above apparatuses providing the wireless communication functionality for the terminal devices 13 are collectively referred to as the access network device in the embodiments of the present disclosure.

Typically, a plurality of terminal devices 13 are provided, and one or more terminal devices 13 may be arranged in a cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices, that is, the terminal devices and UEs mentioned in the embodiments of the present disclosure may be understood as having the same meaning. The access network devices 14 communicate with the core network elements using an air interface technology, such as an NG interface in the 5G NR system. The access network devices 14 communicate with the terminal devices 13 using an air interface technology, such as a Uu interface.

The terminal devices 13 (for example, the in-vehicle device and another device, such as another in-vehicle device, a mobile phone, or a road side unit (RSU)) may communicate with each other over a direct communication interface (for example, a ProSe communication 5 (PC5) interface). Accordingly, the communication link established based on the direct communication interface may be referred to as a direct link or an SL. The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The "5G NR system" in the embodiments of the present disclosure may also be referred to as a 5G system or an NR system, but those skilled in the art can understand the meaning thereof. The technical solutions according to the embodiments of the present disclosure are applicable to the 5G NR system, and also to evolved systems of the 5G NR system.

Before description of the technical solutions of the present disclosure, some relevant technical knowledge involved in the present disclosure is first explained. The following related technologies may be combined with the technical solutions according to the embodiments of the present disclosure in any manner, all of which fall within the scope of protection of the embodiments of the present disclosure. The embodiments of the present disclosure include at least some of the following content.

1. SL PRS transmission

In SL positioning, the location of a target terminal device is determined by an anchor terminal and/or the target terminal device measuring an SL-PRS transmitted by the target terminal device and/or the anchor terminal device. The transmission of the SL-PRS plays a crucial role in positioning.

In related arts, radio access network (RAN) 1 specifies that resource pools for the SL-PRS are categorized into two types: a dedicated resource pool and a shared resource pool. The dedicated resource pool may only carry the SL-PRS. The shared resource pool may carry both the SL-PRS and data. In a case where there is no data to be transmitted, the SL-PRS needs to be assembled with a zero-padding medium access control protocol data unit (zero-padding MAC PDU) to form a transport block that is transmitted from a MAC layer to a physical layer.

2. Hybrid automatic repeat request (HARQ) entity and SL data retransmission

A MAC entity supports at most one sidelink HARQ entity for a sidelink shared channel (SL-SCH) transmission. A sidelink HARQ entity maintains a plurality of parallel sidelink processes.

In the case of an initial transmission of the data, firstly, a sidelink process is mapped to a sidelink grant. Subsequently, the MAC PDU is acquired from a multiplexing and assembly entity, and the MAC PDU, sidelink grant information, and sidelink transmission information are transmitted to the process. The MAC PDU is stored in a buffer area for the HARQ entity (HARQ buffer), and an identity (ID) of the sidelink process is set to the HARQ process ID for the sidelink grant. Subsequently, the sidelink process triggers a transmission of the physical layer.

The content of the sidelink transmission information: The sidelink transmission information included in sidelink control information (SCI) for an SL-SCH transmission as specified in clauses 8.3 and 8.4 of TS 38.212 [9] consists of the sidelink HARQ information, including a network device interface (NDI), a redundancy version (RV), a sidelink process ID, an HARQ feedback enabled/disabled indicator, sidelink identification information (including cast type indicator), a source layer-1 ID, and a destination layer-1 ID, as well as sidelink other information, including a channel state information (CSI) request, a priority, a communication range requirement, and a zone ID.

For retransmission, in a case where no acknowledgment (ACK) feedback is received from a physical sidelink feedback channel (PSFCH), that is:

For each physical sidelink shared channel (PSSCH) transmission, the MAC entity shall:

1> In a case where an acknowledgement corresponding to the PSSCH transmission in clause 5.22.1.3.1a is acquired from the physical layer:

2> deliver the acknowledgement to the corresponding sidelink HARQ entity for the sidelink process;

1> else:

2> deliver a negative acknowledgement (NACK) to the corresponding sidelink HARQ entity for the sidelink process.

Upon receiving the NACK, the HARQ entity transmits a retransmission sidelink grant to the sidelink process. If the sidelink HARQ entity requests a retransmission, the sidelink process shall:

1> store the sidelink grant received from the sidelink HARQ entity;

1> generate a transmission as described below.

Subsequently, the sidelink process triggers a retransmission of the MAC PDU that have already been transmitted once from the HARQ buffer.

How to acquire the retransmitted sidelink grant:

In the case of applying network-assigned SL-grant, in a case where a terminal device feeds back a NACK on an SL to a network device via a physical uplink control channel (PUCCH), the network device may assign a retransmission SL grant to the terminal device via a physical downlink control channel (PDCCH).

In a case where the terminal device autonomously selects an SL grant, the terminal device independently chooses an SL grant from a preset resource pool based on predefined rules.

In sidelink positioning, a target terminal device may be positioned via an SL PRS. For example, an anchor terminal device receives the SL PRS from the target terminal device and measures the SL PRS to determine the position of the target terminal device. Where the anchor terminal device fails to receive the SL PRS transmitted by the target terminal device, the target terminal device may retransmit the SL PRS.

In related arts, resource pools for the SL PRS are categorized into two types: a dedicated resource pool and a shared resource pool. Transmission resources in the dedicated resource pool may only be used to transmit the SL PRS, and transmission resources in the shared resource pool may be used to transmit both the SL PRS and data. However, how to retransmit an SL PRS based on a shared resource pool requires further discussion and research.

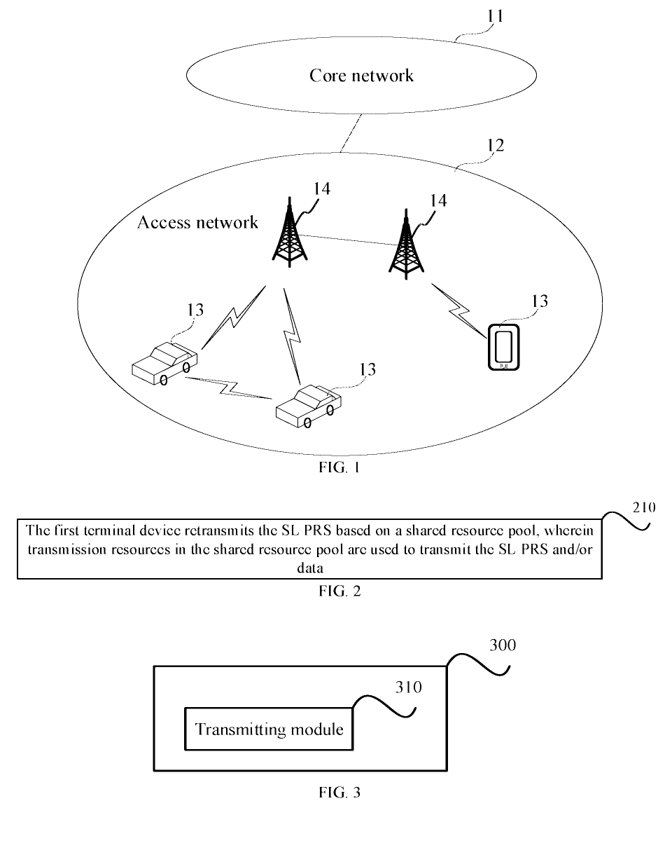

FIG. 2 illustrates a flowchart of a method for retransmitting an SL PRS according to some embodiments of the present disclosure. The method is performed by a first terminal device. The method includes S210.

In S210, the first terminal device retransmits the SL PRS based on a shared resource pool, wherein transmission resources in the shared resource pool are used to transmit the SL PRS and/or data.

Correspondingly, a second terminal device receives the SL PRS retransmitted by the first terminal device based on the shared resource pool.

In some embodiments, the first terminal device transmits the SL PRS to the second terminal device based on the shared resource pool. In a case where the second terminal device has failed to receive the SL PRS, the first terminal device retransmits the SL PRS based on the shared resource pool.

In some embodiments, the transmission resources in the shared resource pool are used to transmit the SL PRS and/or data. In some embodiments, in a case where the SL PRS is retransmitted over resources in the shared resource pool, the SL PRS needs to be assembled with a MAC PDU to form a transmission block transmitted from a MAC layer to a physical layer. In a case where there is data to be transmitted, the MAC PDU may be filled with the data to be transmitted. In a case where there is no data to be transmitted, the MAC PDU may be padded with 0 bits, and in this case, the MAC PDU may be referred to as a zero-padding MAC PDU.

In some embodiments, the first terminal device determines, based on the indication information transmitted by the second terminal device, whether the second terminal device has received the SL PRS, and then determines whether to retransmit the SL PRS. Specifically, regarding how the first terminal device determines whether to retransmit the SL PRS, some embodiments of the present disclosure provide the following schemes.

Scheme 1: The first terminal device determines, based on either first indication information or second indication information, whether to retransmit the SL PRS.

In some embodiments, the first terminal device retransmits the SL PRS to the second terminal device based on the shared resource pool in response to failing to receive the first indication information from the second terminal device, wherein the first indication information is used to indicate that the second terminal device has received the SL PRS.

In some embodiments, in a case where the first terminal device has failed to receive the first indication information from the second terminal device within a first duration, the SL PRS is retransmitted to the second terminal device based on the shared resource pool. In some embodiments, a start time of the first duration is a time instant at which the first terminal device transmits the SL PRS (prior to retransmission). In some embodiments, the first duration is longer than a transmission delay between the first terminal device and the second terminal device. In some embodiments, the first terminal device may count the first duration based on a timer.

In some embodiments, the first terminal device retransmits the SL PRS to the second terminal device based on the shared resource pool in response to receiving the second indication information from the second terminal device, wherein the second indication information is used to indicate that the second terminal device has failed to receive the SL PRS.

In some embodiments, in a case where the first terminal device has failed to receive the first indication information and/or the second indication information from the second terminal device within the first duration, the SL PRS is retransmitted to the second terminal device based on the shared resource pool.

In some embodiments, the first indication information and/or the second indication information are newly defined indication information for a PSFCH. In some embodiments, the first indication information is used to indicate that the second terminal device has received the SL PRS. In some embodiments, the first indication information may be used to indicate that the second terminal device has received the MAC PDU transmitted via the same sidelink grant as the SL PRS, and upon receiving the first indication information, the first terminal device may consider that the second terminal device has failed to receive the SL PRS. In some embodiments, the second indication information is used to indicate that the second terminal device has failed to receive the SL PRS. In some embodiments, the second indication information may be used to indicate that the second terminal device has failed to receive the MAC PDU transmitted via the same sidelink grant as the SL PRS, and upon receiving the second indication information, the first terminal device may consider that the second terminal device has failed to receive the SL PRS.

In some embodiments, both the first indication information and the second indication information may be defined, or only one of them may be defined. For example, in a case where only the first indication information is defined, the second terminal device does not transmit the first indication information to the first terminal device in response to failing to receive the SL PRS. For example, in a case where only the second indication information is defined, the second terminal device does not transmit the second indication information to the first terminal device in response to receiving the SL PRS. For example, in a case where both the first indication information and the second indication information are defined, the second terminal device transmits the first indication information to the first terminal device in response to receiving the SL PRS, and transmits the second indication information to the first terminal device in response to failing to receive the SL PRS.

In some embodiments, a channel for transmitting the SL PRS and a channel for transmitting the first indication information and/or the second indication information may either be the same channel or different channels, which is not limited in the present disclosure. Illustratively, the SL PRS is transmitted in the PSFCH, and the first indication information and/or the second indication information may be transmitted in the PSFCH or in a channel dedicated to transmitting control information (for example, a channel for transmitting sidelink control information).

In some embodiments, only one piece of indication information may be defined, which is used to determine whether the second terminal device has received the SL PRS and/or data. In some embodiments, upon receiving third indication information from the second terminal device, the first terminal device determines, based on the third indication information, whether to retransmit the SL PRS to the second terminal device based on the shared resource pool. In some embodiments, the third indication information includes a first information field and a second information field. The first information field is used to indicate whether the second terminal device has received the MAC PDU transmitted via the same sidelink grant as the SL PRS, and the second information field is used to indicate whether the second terminal device has received the SL PRS. In a case where the second information field indicates that the second terminal device has failed to receive the SL PRS, the first terminal device retransmits the SL PRS to the second terminal device based on the shared resource pool.

In some embodiments, the first indication information and/or the second indication information are determined for indication information for the newly defined channel. In some embodiments, the newly defined channel is used to transmit sidelink data and/or sidelink control information. In some embodiments, the newly defined channel may be used only to transmit the sidelink control information, only to transmit the sidelink data, or to transmit both the sidelink data and the sidelink control information, which is not limited in the present disclosure. In some embodiments, the first indication information and/or the second indication information are specially designed for the newly defined channel. In some embodiments, in a case where the newly defined channel is a channel used only to transmit the sidelink control information, the first indication information and/or the second indication information are specially designed based on requirements for the newly defined channel.

In some embodiments, the channel for transmitting the SL PRS and the channel for transmitting the first indication information and/or the second indication information may be the same channel or different channels, which is not limited in the present disclosure. For example, the SL PRS is transmitted in the PSFCH, and the first indication information and/or the second indication information may be transmitted in the PSFCH or in the newly defined channel.

Scheme 2: The first terminal device determines, based on ACK information or NACK information, whether to retransmit the SL PRS.

In some embodiments, the first terminal device retransmits the SL PRS to the second terminal device based on the shared resource pool in response to receiving the NACK information from the second terminal device, wherein the NACK information is used to indicate that the second terminal device has failed to receive a second MAC PDU.

In some embodiments, the first terminal device retransmits the SL PRS to the second terminal device based on the shared resource pool in response to failing to receive the ACK information from the second terminal device, wherein the ACK information is used to indicate that the second terminal device has received the second MAC PDU.

In some embodiments, the second MAC PDU is a MAC PDU transmitted to the second terminal device via the same sidelink grant as the SL PRS.

In related arts, in a case where a receiver successfully receives the MAC PDU transmitted on the PSFCH, the receiver replies with the ACK information to a transmitter. In a case where the receiver has failed to receive the MAC PDU transmitted on the PSFCH, the receiver replies with the NACK information to the transmitter. In a case where the MAC PDU and the SL PRS are transmitted via the same sidelink grant, the transmitter also retransmits the SL PRS when retransmitting the MAC PDU. Therefore, the ACK information and the NACK information may be reused to determine whether the SL PRS needs to be retransmitted.

In some embodiments, in a case where the first terminal device receives the ACK information from the second terminal device, the first terminal device considers that the second terminal device has successfully received the second MAC PDU and the SL PRS, and in this case, the first terminal device does not retransmit the SL PRS. In some embodiments, in a case where the first terminal device receives the NACK information from the second terminal device, the first terminal device considers that the second terminal device has failed to receive the second MAC PDU and the SL PRS, and in this case, the second terminal device retransmits the second MAC PDU and the SL PRS.

Scheme 3: The first terminal device performs blind retransmission of the SL PRS to determine whether to retransmit the SL PRS.

In some embodiments, the first terminal device performs the blind retransmission of the SL PRS based on the shared resource pool.

In some embodiments, the blind retransmission refers to retransmitting the SL PRS by the first terminal device without reference to HARQ feedback indication information and/or other indication information.

In some embodiments, the scheme of the blind retransmission of the SL PRS by the first terminal device may be determined autonomously by the first terminal device or configured by the network device, which is not limited in the present disclosure.

In some embodiments, the first terminal device may perform the blind retransmission of the SL PRS via a periodic method. Illustratively, the first terminal device transmits the SL PRS to the second terminal device once every time interval T, wherein T is a positive number.

In some embodiments, the first terminal device receives first configuration information from the network device, wherein the first configuration information is used to configure a number of transmissions, the number of transmissions being a maximum number of times for the first terminal device to transmit the SL PRS.

In some embodiments, in the case of the blind retransmission, the network device configures a maximum of 2 or 3 transmission opportunities for the first terminal device, which may be referred to as the number of transmissions. In some embodiments, the number of transmissions includes an initial transmission and retransmissions of the SL PRS. In some embodiments, the number of transmission opportunities configured by the network device for the first terminal device may be determined based on the number of bits in the time resource assignment in downlink control information (DCI). For example, in a case where the number of bits in the time resource assignment is 5, it is considered that the network device configures 2 transmission opportunities for the first terminal device, that is, the first terminal device may transmit one initial transmission and one retransmission of the SL PRS to the second terminal device. For example, in a case where the number of bits in the time resource assignment is 9, it is considered that the network device configures 3 transmission opportunities for the first terminal device, that is, the first terminal device may transmit one initial transmission and two retransmissions of the SL PRS to the second terminal device.

In some embodiments, although the network device configures the number of transmissions for the first terminal device, an actual number of retransmissions of the SL PRS by the first terminal device is still determined autonomously by the first terminal device.

In some embodiments, the first terminal device randomly determines the actual number of retransmissions of the SL PRS based on the number of transmissions. For example, in a case where the network device configures the first terminal device with two retransmission opportunities, the actual number of retransmissions of the SL PRS determined by the first terminal device may be 0, 1, or 2.

In some embodiments, the first terminal device determines the actual number of retransmissions of the SL PRS based on the number of transmissions and a quality of service (QoS) parameter.

In some embodiments, in a case where an accuracy requirement indicated by the QoS parameter is higher than a first threshold, the first terminal device determines the actual number of retransmissions of the SL PRS as a first value.

In some embodiments, in a case where a priority value indicated by the QoS parameter is lower than a second threshold, the first terminal device determines the actual number of retransmissions of the SL PRS as a first value.

In some embodiments, in a case where an accuracy requirement indicated by the QoS parameter is higher than a third threshold, the first terminal device determines the actual number of retransmissions of the SL PRS as a second value.

In some embodiments, in a case where a priority value indicated by the QoS parameter is lower than a fourth threshold, the first terminal device determines the actual number of retransmissions of the SL PRS as a second value.

In some embodiments, the first value is less than the second value, the first threshold is less than the third threshold, and the second threshold is greater than the fourth threshold.

In some embodiments, the first value and the second value are determined based on the number of transmissions. Illustratively, in a case where the number of transmissions is 2, then the first value is 0 and the second value is 1.

In some embodiments, the first threshold, the second threshold, the third threshold, and the fourth threshold may be indicated by the network device, be determined by the terminal device based on own implementation, or be preconfigured, which is not limited in the present disclosure.

In some embodiments, in a case where there are a plurality of possible cases for the actual number of retransmissions, the threshold value of the QoS parameter may be determined based on a selectable number of actual retransmissions. For example, in a case where the number of transmissions configured by the network device is 3, the actual number of retransmissions may be 0, 1, or 2. In this case, taking the priority value indicated by the QoS parameter as an example, in a case where the priority value indicated by the QoS parameter is lower than threshold 1, the first terminal device determines the actual number of retransmissions of the SL PRS as 0; in a case where the priority value indicated by the QoS parameter is lower than threshold 2, the first terminal device determines the actual number of retransmissions for of SL PRS as 1; or in a case where the priority value indicated by the QoS parameter is lower than threshold 3, the first terminal device determines the actual number of retransmissions of the SL PRS as 2; wherein threshold 1 is greater than threshold 2, and threshold 2 is greater than threshold 3.

It should be noted that the above content only uses priority values and accuracy requirements as examples to illustrate the determination of the actual number of retransmissions based on the QoS parameter and the number of transmissions. Other QoS parameters may also be used as criteria for determining the actual number of retransmissions, which is not limited in the present disclosure.

In some embodiments, S210 is performed in a case where a remaining delay budget of the SL PRS is satisfied.

In some embodiments, in a case where the remaining delay budget of the SL PRS has exceeded its time limit, the SL PRS does not need to be retransmitted.

The technical solution according to the embodiments of the present disclosure presents a method for retransmitting the SL PRS based on the shared resource pool, thereby enabling the terminal device to retransmit the SL PRS based on the shared resource pool.

In addition, the conditions for the terminal device to retransmit the SL PRS are provided, which may filter unnecessary retransmissions and reduce the power consumption of the terminal device.

Since transmission resources in the shared resource pool requires that the SL PRS and the MAC PDU be transmitted via the same sidelink grant, during retransmitting the SL PRS, the issue of how to configure and determine the sidelink grant for the retransmitted SL PRS needs to be addressed. To this end, some embodiments of the present disclosure provide some solutions.

Solution 1: Adopting a first MAC PDU

In some embodiments, the first MAC PDU is a MAC PDU with 0-bit padding, which may also be referred to as a zero-padding MAC PDU.

In some embodiments, the first terminal device creates the first MAC PDU, wherein the first MAC PDU is used to retransmit the SL PRS, and the first terminal device transmits the first MAC PDU and the SL PRS to the second terminal device based on the shared resource pool.

In some embodiments, in a case where the first terminal device may not determine whether the second terminal device has successfully received the second MAC PDU and/or the SL PRS, the first terminal device may retransmit the SL PRS using the first MAC PDU and the SL PRS. For example, in a case where the first terminal device employs blind retransmission to retransmit the SL PRS, the first terminal device may use a combination of the first MAC PDU and the SL PRS to retransmit the SL PRS.

In some embodiments, in a case where the first terminal device determines that the second terminal device has successfully received the second MAC PDU but has failed to receive the SL PRS, the first terminal device may use the first MAC PDU and the SL PRS to retransmit the SL PRS. For example, in a case where the indication information received by the first terminal device indicates that the second terminal device has successfully received the second MAC PDU but has failed to receive the SL PRS, the first terminal device may use a combination of the first MAC PDU and the SL PRS to retransmit the SL PRS.

In this way, the first terminal device is enabled to avoid retransmitting the SL PRS using the combination of the second MAC PDU and the SL PRS, thereby reducing the overhead required for retransmitting the SL PRS.

Solution 2: Adopting a second MAC PDU

In some embodiments, the second MAC PDU is a MAC PDU transmitted via the same sidelink grant as the SL PRS.

In some embodiments, the first terminal device acquires the second MAC PDU, and the first terminal device transmits the second MAC PDU and the SL PRS to the second terminal device based on the shared resource pool.

In some embodiments, in a case where the first terminal device determines that the second terminal device has failed to receive the second MAC PDU and/or the SL PRS, the first terminal device may use the second MAC PDU and the SL PRS to retransmit the SL PRS. For example, in a case where the first terminal device determines, based on the NACK information from the second terminal device, that the second terminal device has failed to receive the second MAC PDU, the first terminal device presumes that the second terminal device has failed to receive the SL PRS, and may use a combination of the second MAC PDU and the SL PRS to retransmit the SL PRS.

In this way, not only may the SL PRS be retransmitted, but also the data may be retransmitted.

The exemplary solutions are also provided in the embodiments of the present disclosure for how the first terminal device determines the transmission resources required for retransmission, and how the first terminal device determines the SL PRS during retransmission.

In some embodiments, the first terminal device receives second configuration information from the network device, and the second configuration information is used to configure the transmission resources required for retransmitting the SL PRS.

In some embodiments, the network device transmits the second configuration information to the first terminal device over a PDCCH.

In some embodiments, the first terminal device selects the transmission resources required for retransmitting the SL PRS from the shared resource pool.

In some embodiments, the first terminal device randomly selects the transmission resources required for retransmitting the SL PRS from the shared resource pool.

In some embodiments, the first terminal device selects the transmission resources required for retransmitting the SL PRS based on the remaining delay budget of the SL PRS. Illustratively, the first terminal device selects the transmission resources required for retransmitting the SL PRS within the remaining delay budget of the SL PRS.

In some embodiments, the first terminal device selects the transmission resources required for retransmitting the SL PRS based on a priority of the SL PRS. Illustratively, the transmission resources required for retransmitting the SL PRS are selected according to the priority ranking of the SL PRS and other information (which may be control information, data, etc.) that the first terminal device needs to transmit.

In some embodiments, the first terminal device selects the transmission resources required for retransmitting the SL PRS based on the remaining delay budget of the SL PRS and the priority of the SL PRS. For example, the transmission resources required for retransmitting the SL PRS are selected according to the priority ranking of the SL PRS and other information (which may be the control information, the data, or the like) that the first terminal device needs to transmit, as well as the remaining delay budget of the SL PRS.

In this way, the first terminal device may determine the transmission resources required for retransmitting the SL PRS.

In some embodiments, the SL PRS is retrieved from an HARQ buffer, and the SL PRS is stored in the HARQ buffer during the initial transmission.

In some embodiments, the SL PRS is stored in the HARQ buffer during the initial transmission. In a case where the SL PRS needs to be retransmitted, the SL PRS may be retrieved from the HARQ buffer.

In some embodiments, an identifier corresponding to the SL PRS is acquired from a radio resource control (RRC) layer, and the SL PRS is determined based on the identifier corresponding to the SL PRS.

In some embodiments, the SL PRS is determined by a sequence specified by a higher layer, and the MAC layer may again acquire the identifier corresponding to the SL PRS from the higher layer to determine the SL PRS. Herein, the higher layer refers to a protocol layer above the MAC layer, for example, the RRC layer. Illustratively, the MAC layer may transmit SL PRS retransmission indication information to the RRC layer, which is used to acquire the identifier corresponding to the SL PRS. The RRC layer transmits the identifier corresponding to the SL PRS to the MAC layer, and the MAC layer may determine the SL PRS based on the identifier of the SL PRS.

In some embodiments, upon determining the SL PRS, the MAC layer transmits the SL PRS and the first MAC PDU (or the second MAC PDU) to the physical layer, and then the physical layer transmits the SL PRS and the first MAC PDU (or the second MAC PDU) to the second terminal device.

In this way, the first terminal device may determine the SL PRS used for retransmission.

In the method embodiments described above, the technical solution of the present disclosure is introduced and explained solely from the perspective of interaction between the first terminal device and the second terminal device. The steps performed by the first terminal device may be independently implemented as a method for retransmitting the SL PRS at the first terminal device, and the steps performed by the second terminal device may be independently implemented as a method for retransmitting the SL PRS at the second terminal device. Furthermore, the embodiments according to the present disclosure may be arbitrarily combined to form new embodiments, all of which fall within the scope of protection of the present disclosure.

The following is embodiments of an apparatus of the present disclosure, which may be used to implement the method embodiments of the present disclosure. For details not disclosed in the apparatus embodiments of the present disclosure, please refer to the method embodiments of the present disclosure.

FIG. 3 illustrates a block diagram of an apparatus for retransmitting an SL PRS according to some embodiments of the present disclosure. The apparatus has functions for implementing the method embodiments for retransmitting the SL PRS, and the functions may be implemented by hardware, or by hardware executing corresponding software. The apparatus may be the first terminal device described above, or may be provided in the first terminal device. As illustrated in FIG. 3, the apparatus 300 includes: a transmitting module 310.

The transmitting module 310 is configured to retransmit the SL PRS based on a shared resource pool, wherein transmission resources in the shared resource pool are used to transmit the SL PRS and/or data.

In some embodiments, the transmitting module 310 is configured to retransmit the SL PRS to a second terminal device based on the shared resource pool in response to failing to receive first indication information from the second terminal device, wherein the first indication information is used to indicate that the second terminal device has received the SL PRS; or

wherein the transmitting module is configured to retransmit the SL PRS to a second terminal device based on the shared resource pool in response to receiving second indication information from the second terminal device, wherein the second indication information is used to indicate that the second terminal device has failed to receive the SL PRS.

In some embodiments, the transmitting module 310 is configured to create a first MAC PDU, wherein the first MAC PDU is used to retransmit the SL PRS; and is configured to transmit the first MAC PDU and the SL PRS to the second terminal device based on the shared resource pool.

In some embodiments, the transmitting module 310 is configured to retransmit the SL PRS to a second terminal device based on the shared resource pool in response to receiving negative acknowledgment (NACK) information from the second terminal device, wherein the NACK information is used to indicate that the second terminal device has failed to receive a second MAC PDU; or

the transmitting module 310 is configured to retransmit the SL PRS to a second terminal device based on the shared resource pool in response to failing to receive ACK information from the second terminal device, wherein the ACK information is used to indicate that the second terminal device has received a second MAC PDU;

wherein the second MAC PDU is a MAC PDU transmitted to the second terminal device via the same sidelink grant as the SL PRS.

In some embodiments, the transmitting module 310 is configured to acquire the second MAC PDU; and is configured to transmit the second MAC PDU and the SL PRS to the second terminal device based on the shared resource pool.

In some embodiments, the transmitting module 310 is configured to perform blind retransmission of the SL PRS based on the shared resource pool.

In some embodiments, the transmitting module 310 is configured to create a first MAC PDU, wherein the first MAC PDU is used to retransmit the SL PRS; and is configured to transmit the first MAC PDU and the SL PRS to a second terminal device based on the shared resource pool.

In some embodiments, the apparatus further includes: a receiving module (not illustrated in the figure).

The receiving module is configured to receive first configuration information from a network device, wherein the first configuration information is used to configure a number of transmissions, the number of transmissions being a maximum number of times for the first terminal device to transmit the SL PRS.

In some embodiments, the apparatus further includes: a processing module (not illustrated in the figure).

The processing module is configured to randomly determine an actual number of retransmissions of the SL PRS based on the number of transmissions; or

the processing module is configured to determine an actual number of retransmissions of the SL PRS based on the number of transmissions and a QoS parameter.

In some embodiments, the processing module is configured to determine the actual number of retransmissions of the SL PRS as a first value in a case where an accuracy requirement indicated by the QoS parameter is higher than a first threshold; or

the processing module is configured to determine the actual number of retransmissions of the SL PRS as a first value in a case where a priority value indicated by the QoS parameter is lower than a second threshold; or

the processing module is configured to determine the actual number of retransmissions of the SL PRS as a second value in a case where an accuracy requirement indicated by the QoS parameter is higher than a third threshold; or

the processing module is configured to determine the actual number of retransmissions of the SL PRS as a second value in a case where a priority value indicated by the QoS parameter is lower than a fourth threshold;

wherein the first value is less than the second value, the first threshold is less than the third threshold, and the second threshold is greater than the fourth threshold.

In some embodiments, the receiving module is configured to receive second configuration information from a network device, wherein the second configuration information is used to configure transmission resources required for retransmitting the SL PRS; or

the receiving module is configured to select transmission resources required for retransmitting the SL PRS from the shared resource pool.

In some embodiments, the transmitting module 310 is configured to retransmit the SL PRS based on the shared resource pool in a case where a remaining delay budget of the SL PRS is satisfied.

In some embodiments, the processing module is configured to acquire the SL PRS from an HARQ buffer, wherein the SL PRS is stored in the HARQ buffer during an initial transmission; or

the processing module, configured to acquire an identifier corresponding to the SL PRS from an RRC layer, and determine the SL PRS based on the identifier corresponding to the SL PRS.

The technical solution according to the embodiments of the present disclosure presents a method for retransmitting the SL PRS based on the shared resource pool, thereby enabling the terminal device to perform retransmissions of the SL PRS based on the shared resource pool.

In addition, the conditions for the terminal device to retransmit the SL PRS are provided, which may filter unnecessary retransmissions and reduce the power consumption of the terminal device.

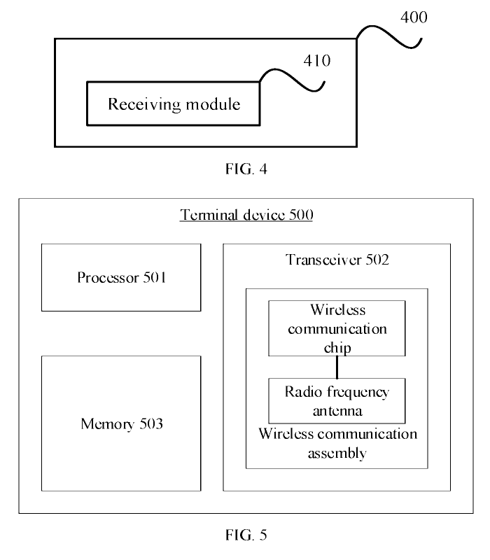

FIG. 4 illustrates a block diagram of an apparatus for retransmitting an SL PRS according to some embodiments of the present disclosure. The apparatus has functions for implementing the method embodiments for retransmitting the SL PRS, and the functions may be implemented by hardware, or by hardware executing corresponding software. The apparatus may be the second terminal device described above, or may be provided in the second terminal device. As illustrated in FIG. 4, the apparatus 400 includes: a receiving module 410.

The receiving module 410 is configured to receive the SL PRS retransmitted by a first terminal device based on a shared resource pool, wherein transmission resources in the shared resource pool are used to transmit the SL PRS and/or data.

In some embodiments, the retransmitted SL PRS is transmitted by the first terminal device in response to failing to receive the first indication information from the second terminal device, wherein the first indication information is used to indicate that the second terminal device has received the SL PRS; or

the retransmitted SL PRS is transmitted by the first terminal device in response to receiving the second indication information from the second terminal device, wherein the second indication information is used to indicate that the second terminal device has failed to receive the SL PRS.

In some embodiments, the receiving module 410 is configured to receive a first MAC PDU and the SL PRS from the first terminal device based on the shared resource pool, wherein the first MAC PDU is used to retransmit the SL PRS.

In some embodiments, the retransmitted SL PRS is transmitted by the first terminal device in response to receiving NACK information from the second terminal device, wherein the NACK information is used to indicate that the second terminal device has failed to receive a second MAC PDU; or

the retransmitted SL PRS is transmitted by the first terminal device in response to failing to receive ACK information from the second terminal device, wherein the ACK information is used to indicate that the second terminal device has received a second MAC PDU;

wherein the second MAC PDU is a MAC PDU transmitted to the second terminal device via the same sidelink grant as the SL PRS.

In some embodiments, the receiving module 410 is configured to receive the second MAC PDU and the SL PRS from the first terminal device based on the shared resource pool.

In some embodiments, the receiving module 410 is configured to receive the SL PRS retransmitted by the first terminal device by means of blind retransmission based on the shared resource pool.

In some embodiments, the receiving module 410 is configured to receive a first MAC PDU and the SL PRS transmitted by the first terminal device by means of the blind retransmission based on the shared resource pool, wherein the first MAC PDU is used to retransmit the SL PRS.

In some embodiments, a number of transmissions of the SL PRS is configured by a network device, the number of transmissions being a maximum number of times for the first terminal device to transmit the SL PRS.

In some embodiments, an actual number of retransmissions of the SL PRS is randomly determined based on the number of transmissions; or

an actual number of retransmissions of the SL PRS is determined based on the number of transmissions and a QoS parameter.

In some embodiments, in a case where an accuracy requirement indicated by the QoS parameter is higher than a first threshold, the actual number of retransmissions of the SL PRS is determined as a first value; or

in a case where a priority value indicated by the QoS parameter is lower than a second threshold, the actual number of retransmissions of the SL PRS is determined as a first value; or

in a case where an accuracy requirement indicated by the QoS parameter is higher than a third threshold, the actual number of retransmissions of the SL PRS is determined as a second value; or

in a case where a priority value indicated by the QoS parameter is lower than a fourth threshold, the actual number of retransmissions of the SL PRS is determined as a second value;

wherein the first value is less than the second value, the first threshold is less than the third threshold, and the second threshold is greater than the fourth threshold.

In some embodiments, transmission resources required for retransmitting the SL PRS are configured by a network device; or

transmission resources required for retransmitting the SL PRS are selected by the first terminal device from the shared resource pool.

In some embodiments, the retransmitted SL PRS is transmitted in a case where a remaining delay budget of the SL PRS is satisfied.

In some embodiments, the retransmitted SL PRS is acquired from an HARQ buffer, wherein the SL PRS is stored in the HARQ buffer during an initial transmission; or

the retransmitted SL PRS is determined based on an identifier corresponding to the SL PRS, wherein the identifier corresponding to the SL PRS is acquired from an RRC layer.

The technical solution according to the embodiments of the present disclosure presents a method for retransmitting the SL PRS based on the shared resource pool, thereby enabling the terminal device to perform retransmissions of the SL PRS based on the shared resource pool.

In addition, the conditions for the terminal device to retransmit the SL PRS are provided, which may filter unnecessary retransmissions and reduce the power consumption of the terminal device.

It should be noted that when implementing the functions of the apparatus according to the above embodiments, the division of the various functional modules is merely exemplary. In practical applications, the above functions may be assigned to different functional modules according to actual needs, i.e., the content structure of the device can be divided into different functional modules to accomplish all or part of the above functions.

With regard to the apparatus in the above embodiments, the specific mode in which each module performs the operation has been described in detail in the embodiments related to the method and will not be described in detail herein.

FIG. 5 illustrates a schematic structural diagram of a terminal device according to some embodiments of the present disclosure. The terminal device 500 includes: a processor 501, a transceiver 502, and a memory 503. The transceiver 502 is configured to implement transmitting or receiving functions, such as implementing functions of the transmitting module 310 or implementing functions of the receiving module 410. The processor 501 may be configured to implement other processing functions or control transmitting and/or receiving.

The processor 501 may include one or more processing cores, and the processor 501 executes various functional applications and performs information processing by running software programs and modules.

The transceiver 502 may include a receiver and a transmitter, which are practiced, for example, as the same wireless communication assembly that includes a wireless communication chip and a radio frequency antenna.

The memory 503 may be connected to the processor 501 and the transceiver 502.

The memory 503 may be configured to store one or more computer programs loaded and run by the processor, and the processor 501 is configured to load and run the one or more computer programs to perform the processes in the above method embodiments.

In some embodiments, the transceiver 502 is configured to retransmit the SL PRS based on a shared resource pool, wherein transmission resources in the shared resource pool are used to transmit the SL PRS and/or data.

In some embodiments, the transceiver 502 is configured to receive the SL PRS retransmitted by a first terminal device based on a shared resource pool, wherein transmission resources in the shared resource pool are used to transmit the SL PRS and/or data.

For details not specified in the embodiments, reference is made to the foregoing embodiments, which are not repeated herein.

In addition, the memory may be implemented by any type or combination of volatile or non-volatile storage devices, including, but not limited to: a magnetic or optical disc, an electrically erasable programmable read-only memory, an erasable programmable read-only memory, a static random-access memory, a read-only memory (ROM), a magnetic memory, a flash memory, and a programmable read-only memory.

The embodiments of the present disclosure further provide a computer-readable storage medium storing one or more computer programs therein. The one or more computer programs, when loaded and run by a processor, cause the processor to perform the method for retransmitting the SL PRS described above at the first terminal device, or the method for retransmitting the SL PRS described above at the second terminal device. In some embodiments, the computer-readable storage medium includes: a ROM, a random-access memory (RAM), a solid state drive (SSD), an optical disk, etc. The RAM includes a resistance random-access memory (ReRAM) and a dynamic random access memory (DRAM).

The embodiments of the present disclosure further provide a chip including programmable logic circuitry and/or one or more program instructions. The chip, when running, is caused to perform the method for retransmitting the SL PRS described above at the first terminal device, or the method for retransmitting the SL PRS described above at the second terminal device.

The embodiments of the present disclosure further provide a computer program product. The computer program product includes at least one computer program stored in a computer-readable storage medium. The at least one computer program, when read from the computer-readable storage medium and executed by a processor, causes the processor to perform the method for retransmitting the SL PRS described above at the first terminal device, or the method for retransmitting the SL PRS described above at the second terminal device.

It should be understood that the term "indication" mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term "correspond" indicates a direct or indirect corresponding relationship between two items, or indicates an associated relationship between the two items; and also indicates relationships such as indicating and being indicated, or configuring and being configured.

In some embodiments of the present disclosure, the term "predefined" is implemented by pre-storing corresponding codes, tables, or other means that may be defined to indicate related information in devices (including, for example, terminal devices and network devices), and the present disclosure does not limit the specific implementation thereof. For example, "predefined" refers to "defined" in a protocol.

In some embodiments of the present disclosure, the "protocol" refers to a standard protocol in the communication field including, for example, the LTE protocol, the NR protocol, and related protocols applied in future communication systems, which is not limited in the present disclosure.

The mentioned term "a plurality of" herein means two or more. The term "and/or" describes the association relationship between the associated objects, and indicates that three relationships may be present. For example, the phrase "A and/or B" means (A), (B), or (A and B). The symbol "/" generally indicates an "or" relationship between the associated objects.

Reference herein to "greater than or equal to" may indicate greater than or equal to or just greater than, and "less than or equal to" may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Combinations such as "at least one of A, B, or C," "at least one of A, B, and C," and "A, B, C, or any combination thereof" include any combination of A, B, and/or C, and may include multiples of A, multiples of B, or multiples of C. Specifically, combinations such as "at least one of A, B, or C," "at least one of A, B, and C," and "A, B, C, or any combination thereof" may be A only, B only, C only, A and B, A and C, B and C, or A and B and C, where any such combinations may contain one or more member or members of A, B, or C.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for retransmitting a sidelink positioning reference signal (SL PRS), performed by a first terminal device, the method comprising:
retransmitting the SL PRS based on a shared resource pool, wherein transmission resources in the shared resource pool are used to transmit the SL PRS and/or data.

2. The method according to claim 1, wherein retransmitting the SL PRS based on the shared resource pool comprises:
retransmitting the SL PRS to a second terminal device based on the shared resource pool in response to failing to receive first indication information from the second terminal device, wherein the first indication information is used to indicate that the second terminal device has received the SL PRS; or
retransmitting the SL PRS to a second terminal device based on the shared resource pool in response to receiving second indication information from the second terminal device, wherein the second indication information is used to indicate that the second terminal device has failed to receive the SL PRS.

3. The method according to claim 2, wherein retransmitting the SL PRS to the second terminal device based on the shared resource pool comprises:
creating a first medium access control (MAC) protocol data unit (PDU), wherein the first MAC PDU is used to retransmit the SL PRS; and
transmitting the first MAC PDU and the SL PRS to the second terminal device based on the shared resource pool.

4. The method according to claim 1, wherein retransmitting the SL PRS based on the shared resource pool comprises:
performing blind retransmission of the SL PRS based on the shared resource pool.

5. The method according to claim 1, further comprising:
receiving second configuration information from a network device, wherein the second configuration information is used to configure transmission resources required for retransmitting the SL PRS; or
selecting transmission resources required for retransmitting the SL PRS from the shared resource pool.

6. The method according to claim 1, further comprising:
retransmitting the SL PRS based on the shared resource pool in a case where a remaining delay budget of the SL PRS is satisfied.

7. The method according to claim 1, further comprising:
acquiring the SL PRS from a hybrid automatic repeat request (HARQ) buffer, wherein the SL PRS is stored in the HARQ buffer during an initial transmission; or
acquiring an identifier corresponding to the SL PRS from a radio resource control (RRC) layer, and determining the SL PRS based on the identifier corresponding to the SL PRS.

8. A first terminal device, comprising: a processor and a memory storing one or more computer programs, wherein the one or more computer programs, when executed by the processor, cause the first terminal device to:
retransmit a sidelink positioning reference signal (SL PRS) based on a shared resource pool, wherein transmission resources in the shared resource pool are used to transmit the SL PRS and/or data.

9. The first terminal device according to claim 8, wherein the one or more computer programs, when executed by the processor, cause the first terminal device to:
retransmit the SL PRS to a second terminal device based on the shared resource pool in response to receiving negative acknowledgment (NACK) information from the second terminal device, wherein the NACK information is used to indicate that the second terminal device has failed to receive a second medium access control (MAC) protocol data unit (PDU); or
retransmit the SL PRS to a second terminal device based on the shared resource pool in response to failing to receive acknowledgment (ACK) information from the second terminal device, wherein the ACK information is used to indicate that the second terminal device has received a second MAC PDU;
wherein the second MAC PDU is a MAC PDU transmitted to the second terminal device via the same sidelink grant as the SL PRS.

10. The first terminal device according to claim 9, wherein the one or more computer programs, when executed by the processor, cause the first terminal device to:
acquire the second MAC PDU, and transmit the second MAC PDU and the SL PRS to the second terminal device based on the shared resource pool.

11. The first terminal device according to claim 8, wherein the one or more computer programs, when executed by the processor, cause the first terminal device to:
perform blind retransmission of the SL PRS based on the shared resource pool.

12. The first terminal device according to claim 8, wherein the one or more computer programs, when executed by the processor, further cause the first terminal device to:
receive second configuration information from a network device, wherein the second configuration information is used to configure transmission resources required for retransmitting the SL PRS; or
select transmission resources required for retransmitting the SL PRS from the shared resource pool.

13. The first terminal device according to claim 8, wherein the one or more computer programs, when executed by the processor, further cause the first terminal device to:
retransmit the SL PRS based on the shared resource pool in a case where a remaining delay budget of the SL PRS is satisfied.

14. The first terminal device according to claim 8, wherein the one or more computer programs, when executed by the processor, further cause the first terminal device to:
acquire the SL PRS from a hybrid automatic repeat request (HARQ) buffer, wherein the SL PRS is stored in the HARQ buffer during an initial transmission; or
acquire an identifier corresponding to the SL PRS from a radio resource control (RRC) layer, and determine the SL PRS based on the identifier corresponding to the SL PRS.

15. A second terminal device, comprising: a processor and a memory storing one or more computer programs, wherein the one or more computer programs, when executed by the processor, cause the second terminal device to:
receive a sidelink positioning reference signal (SL PRS) retransmitted by a first terminal device based on a shared resource pool, wherein transmission resources in the shared resource pool are used to transmit the SL PRS and/or data.

16. The second terminal device according to claim 15, wherein the one or more computer programs, when executed by the processor, cause the second terminal device to:
receive the SL PRS retransmitted by the first terminal device by means of blind retransmission based on the shared resource pool.

17. The second terminal device according to claim 16, wherein the one or more computer programs, when executed by the processor, cause the second terminal device to:
receive a first medium access control (MAC) protocol data unit (PDU) and the SL PRS transmitted by the first terminal device by means of the blind retransmission based on the shared resource pool, wherein the first MAC PDU is used to retransmit the SL PRS.

18. The second terminal device according to claim 16, wherein a number of transmissions of the SL PRS is configured by a network device, the number of transmissions being a maximum number of times for the first terminal device to transmit the SL PRS.

19. The second terminal device according to claim 18, wherein
an actual number of retransmissions of the SL PRS is randomly determined based on the number of transmissions; or
an actual number of retransmissions of the SL PRS is determined based on the number of transmissions and a quality of service (QoS) parameter.

20. The second terminal device according to claim 19, wherein
in a case where an accuracy requirement indicated by the QoS parameter is higher than a first threshold, the actual number of retransmissions of the SL PRS is determined as a first value; or
in a case where a priority value indicated by the QoS parameter is lower than a second threshold, the actual number of retransmissions of the SL PRS is determined as a first value; or
in a case where an accuracy requirement indicated by the QoS parameter is higher than a third threshold, the actual number of retransmissions of the SL PRS is determined as a second value; or
in a case where a priority value indicated by the QoS parameter is lower than a fourth threshold, the actual number of retransmissions of the SL PRS is determined as a second value;
wherein the first value is less than the second value, the first threshold is less than the third threshold, and the second threshold is greater than the fourth threshold.
